(19) United States
(12) Patent Application Publication
(10) Pub. No.: US 2010/0123039 A1
(43) Pub. Date: May 20, 2010

(54) Tail rotor system and method for controlling a tail rotor system

(76) Inventors: Andreas Buhl, Oberstaufen (DE); Michael Koros, Lindenberg (DE)

Correspondence Address: DILWORTH & BARRESE, LLP, 1000 WOODBURY ROAD, SUITE 405, WOODBURY, NY, 11797, US

(21) Appl. No.: 12/317,313

(22) Filed: Dec. 22, 2008

(30) Foreign Application Priority Data
Nov. 17, 2008 (DE) 10 2008 057 715.4

(51) Int. Cl. B64C 27/82

(52) U.S. Cl. 244/17.19

(57) ABSTRACT

The present invention relates to a tail rotor system for an aircraft, in particular for a helicopter, with a multi-blade tail rotor with fixed blade angle of attack and to a method for controlling a tail rotor system for an aircraft, in particular for a helicopter.

The present invention relates to a tail rotor system for an aircraft, in particular for a helicopter, with a multi-blade tail rotor with fixed blade angle of attack and to a method for controlling a tail rotor system for an aircraft, in particular for a helicopter.

As main drive, helicopters usually have single-rotor systems, wherein a torque or yawing moment is produced about the axis of the main rotor, which causes a rotation of the helicopter opposite to the rotation of the rotor. To prevent this, either a coaxial main rotor, a tandem main rotor or intermeshing main rotors usually are employed for torque compensation and for yaw control. In classical main and tail rotor configurations, an air flow deflection in the tail boom and/or a configuration with main and tail rotors alternatively is provided for torque compensation and for yaw control.

Via a mechanical shafting, the tail rotor is firmly connected with the main transmission and is thereby driven mechanically. The tail rotor blade angle of attack is varied via an actuating drive.

Thus, conventionally driven tail rotors with a fixed rotational speed are used for torque compensation and yaw control of a helicopter by means of shafts from the main transmission and a variable blade adjustment by means of actuating drives.

The shafts and transmissions to the tail rotor and the load path in the actuating drive are only constructed simple for weight reasons.

A further problem of conventional main rotor/tail rotor systems is the fact that the tail rotor requires up to about 20% of the engine performance of the main drive and in addition has a superproportional share in the noise generated by a helicopter.

With respect to the aforementioned problems, the prior art already has proposed possible solutions which, however, only partly can cope with the aforementioned problems.

From EP 0 680 871 B1, an encapsulated tail rotor is known, wherein by means of encapsulation and phase modulation of the rotor blade adjustment the accident risk by the tail rotor should be reduced on the one hand and at the same time the generation of noise should be reduced. The tail rotor is driven with its motor shaft, which in turn is driven by a drive shaft extending through the tail boom and is connected with a secondary outlet of the main trainsmission of the helicopter.

U.S. Pat. No. 4,953,811 relates to an encapsulated, self-propelling tail rotor system, in which the tail rotor is driven magnetically. The magnets are disposed circumferentially in the tail rotor encapsulation, so that the magnetic tail rotor blades can be driven by changing the magnetic field.

In addition, WO 2007/080617 A1 discloses a tail rotor system with a multi-blade tail rotor, which is driven by a hydraulic drive connected with the main drive system of the helicopter.

However, none of the aforementioned solutions is able to solve all the problems of main rotor/tail rotor configurations described above.

Therefore, it is the object of the present invention to advantageously develop a tail rotor system for an aircraft as mentioned above, in particular to the effect that it can be manufactured and operated in a more efficient, safe, and less expensive way and above all by reducing the criticality of the components.

In accordance with the invention, this object is solved by a tail rotor system with the features of claim 1. Accordingly, it is provided that the tail rotor system for an aircraft, in particular for a helicopter, is equipped with a multi-blade tail rotor with fixed blade angle of attack, wherein the tail rotor system includes redundant drive units. By means of the drive units, it is possible to avoid the mechanical coupling of the tail rotor with the main drive. This provides the advantage that e.g. in a helicopter with main and tail rotors, the tail rotor output shaft or the tail rotor output device on the main transmission, the tail rotor shafting with bearing, a reversing gear in the tail rotor shafting, the tail rotor actuating drive together with the string of position commands, the tail rotor swash plate and corresponding movable parts between swash plate and tail rotor blades can be omitted. By introducing redundant drive units, which beside the actual drive units also can comprise the associated drive trains, a reduction of the criticality of components is achieved. Due to the redundancy, the operational safety of the aircraft is increased. Despite the redundancy of the drive units for the tail rotor system, a distinct reduction of the helicopter weight is obtained altogether, which has, a positive effect on the performance data of the helicopter. Due to the reduced consumption, for instance, the helicopter can achieve a greater range, and/or due to the improved relation between performance and weight higher velocities and/or a higher payload. Another advantage consists in that the continuous mechanical drive by the previously necessary coupling to the main drive is omitted, since the tail rotor can be operated by the drive units independent of the rotary movement of the main rotor.

Furthermore, it can be provided that the drive units are driven by means of at least one electric and/or hydraulic power source. This power source can consist in one or more generators or one or more hydraulic drives.

In addition, it is possible that at least one power source is connected with the main drive of the aircraft. However, since a mechanical dissipation from the main drive of the aircraft to the tail rotor advantageously is not effected, this is accompanied by reduced power losses. Preferably, one or more generators and/or one or more hydraulic drives are directly and/or indirectly supplied by the main drive.

Furthermore, it is possible that control and/or regulating means are provided, by means of which the drive units can be controlled and/or regulated in terms of rotational speed and/or direction of rotation. The control and/or regulating means can consist in a central control and regulating unit for the tail rotor or comprise such central control and regulating unit, together with further control and/or regulating means. In particular, it can be provided that the control and/or regulating means likewise are provided redundantly.

Particularly advantageously, separate control and/or regulating means are associated to each drive unit. In this way, a higher degree of redundancy is achieved.

Furthermore, it is conceivable that the control and/or regulating means are connected with the central control and/or regulation of the aircraft. The central control can be the flight control computer of the aircraft.

Furthermore, it can be provided that the control and/or regulating means are directly and/or indirectly connected with position detecting elements and/or with steering means of the aircraft. The position detecting elements can comprise position sensors for yaw control or be configured as such, wherein the position sensors advantageously are connected with the flight control computer, i.e. the central control and/or regulation of the aircraft. The steering means can comprise a yaw control device such as pedals and/or a sidestick or be configured as such. The elements of the yaw control device advantageously are connected with the position sensors for yaw control and with the flight control computer.

By means of the control and/or regulating means in cooperation with the position detecting elements and/or the steering means and/or the central control and/or regulation of the aircraft, the tail rotor advantageously can be controlled and/or regulated, preferably automatically, in terms of rotational speed and/or direction of rotation for yaw control and/or regulation. The automatic control and/or regulation of the yaw movement of the aircraft can for instance be performed by the flight control computer, taking into account the steering movements specified by the pilot, whereby the pilot is relieved. Thereby, the operational safety of the aircraft is increased further.

Furthermore, it can be provided that by means of the control and/or regulating means in cooperation with the position detecting elements and/or the steering means and/or the central control and/or regulation of the aircraft a signal can be determined, by means of which it can be read off whether the tail rotor must be activated for influencing the yaw control, and wherein the tail rotor can be activated and/or deactivated in dependence on this signal. This provides the advantage that energy only is consumed if this actually is required also for torque generation and hence for yaw control of the helicopter. From a certain forward velocity of the helicopter, stabilizing the aircraft advantageously can be effected by aerodynamic effects on the fuselage, e.g. by tail units and by the tail boom. Hence, a torque generated by the tail rotor becomes superfluous for yaw control. In addition, this involves the advantage that noise emissions can be reduced, since the tail rotor only must be activated if necessary, namely if torque compensation goes beyond the aerodynamic effect. Furthermore, it is advantageous that the parasitic or induced drag of the helicopter can be reduced, since the tail rotor only is operated when this is actually necessary for yaw control.

It is conceivable that the tail rotor includes a shaft which also is the rotor of the redundant drive units. It can be advantageous when the preferably electric drive units for instance are arranged one beside the other as stator around the shaft. In particular, it is advantageous when all components of the tail rotor system with the exception of the tail rotor shaft are of the redundant type. In principle, it can be provided that the tail rotor is realized in an encapsulated or open form.

This invention furthermore relates to a method for controlling a tail rotor system of an aircraft, in particular of a helicopter, with the features of claim 11. Accordingly, it is provided that a method for controlling a tail rotor system of an aircraft, in particular of a helicopter, with a multi-blade tail rotor with fixed blade angle of attack is performed such that the tail rotor is driven redundantly.

In addition, it can be provided that the tail rotor is activated if necessary and/or the yaw movement of the aircraft is controlled and/or regulated, preferably automatically, by the rotational speed and direction of rotation of the tail rotor in dependence on the position of the aircraft and/or in dependence on the existing control commands. It is particularly advantageous that the tail rotor can be actuated independent of the rotary movement of the main rotor and can be operated discontinuously.

Furthermore, it is possible that the tail rotor system includes redundant drive units and that control and/or regulating means are provided, by means of which the drive units are controlled and/or regulated in terms of rotational speed and/or direction of rotation, wherein upon failure of one or more drive units and/or one or more control and/or regulating means the tail rotor can be operated further by the remaining drive units. In this way, the reliability of the entire tail rotor system advantageously can be increased, which in general increases the operational safety of the aircraft.

Furthermore, it is conceivable that the tail rotor is not driven in a flight-dynamically stable position of the aircraft. In this way, the efficiency of the aircraft can be increased. Furthermore, the generation of noise by the tail rotor system is substantially reduced, since the same only is activated if necessary.

Preferably, the method for controlling a tail rotor system is performed with a tail rotor system according to any of claims 1 to 9.

Further details and advantages of the invention will now be explained in detail with reference to an embodiment illustrated in the drawing, in which:

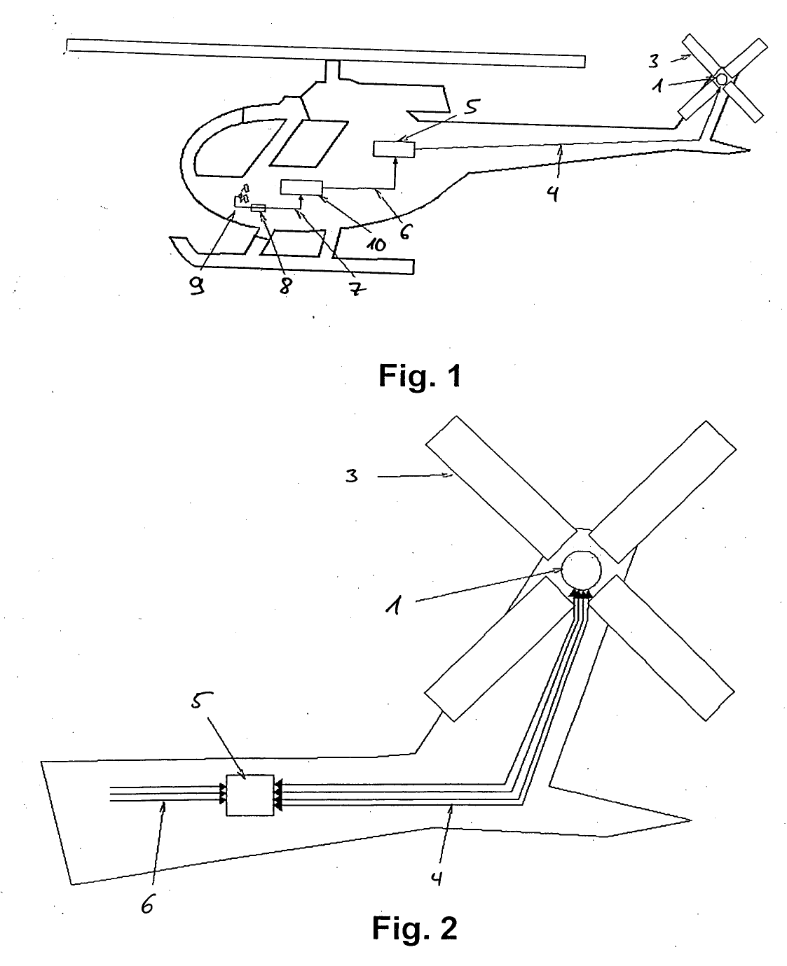

FIG. 1: shows a schematic view of an aircraft in a side view,

FIG. 2: shows a schematic view of the tail boom of an aircraft with tail rotor in a side view, and

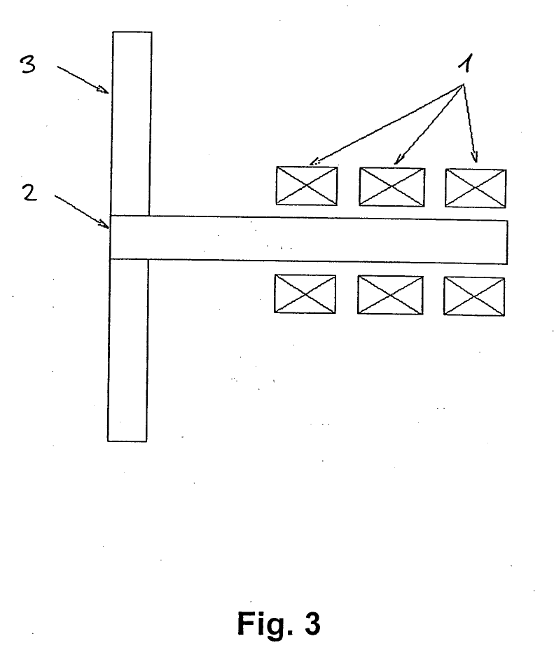

FIG. 3: shows a detailed schematic view of the tail rotor.

FIG. 1 shows a schematic side view of a helicopter with a tail rotor system in accordance with the invention. There is provided a multi-blade tail rotor 3 with fixed blade angle of attack, in the case shown in FIG. 1 with four symmetrically arranged tail rotor blades. The tail rotor system shown in FIG. 1 has a plurality of redundant drive units, which are configured as multiredundant electric or hydraulic motors.

The helicopter is provided with a yaw control device 9, which selectively can, be configured as pedals or also as a sidestick. Furthermore, position sensors are provided, which detect the position of the control devices and generate a signal for the desired yaw control moment. Via the position sensors for the yaw control device position, the yaw control device 9 is connected with the flight control computer by means of preferably redundant signal lines. The signals 7 of the yaw control device position are provided to the flight control computer.

The tail rotor system includes a redundant control and regulating unit 5, which is connected with the drive units 1 of the tail rotor 3 by means of a multiredundant energy supply and control line 4. Via a multiredundant power and signal supply, the control and regulating unit 5 furthermore is connected with the flight control computer 10 via the line 6. Line 6 advantageously is configured as a multiredundant bundel of lines.

FIG. 2 shows a modified arrangement of the control and regulating unit 5, which instead of being accommodated in the actual helicopter cabin now is arranged in the rear part of the tail boom, which also carries the open tail rotor 3. The power and signal supply from the main drive of the helicopter and from the flight control computer 10 via the lines 6 is effected multiredundantly, just as forwarding from the control and regulating unit 5 to the drive units 1 by means of the supply and/or control lines 4. In principle, it can be provided that the control and regulating unit 5 is of the redundant type. In a single housing of a control and regulating unit 5, component redundancy can exist. However, a plurality of redundantly and separately arranged control and regulating units 5 can also be provided.

FIG. 3 shows multiredundant electric motors 1 arranged redundantly around the common shaft 2, which drive the tail rotor 3. The shaft 2 also serves as rotor of the multiredundant drive units 1. In principle, it can be provided that instead of or in addition to the electric motors 1 hydraulic motors 1 are used. By using different types of drive in combination, the redundancy of the system can be increased.

1. A tail rotor system for an aircraft, in particular for a helicopter, with a multi-blade tail rotor (3) with a fixed blade angle of attack, wherein the tail rotor system includes redundant drive units (1), which combine both yaw thrust generation and yaw thrust control in one unit.

2. The tail rotor system according to claim 1, wherein the drive units (1) are driven by at least one electric and/or hydraulic power source.

3. The tail rotor system according to claim 2, wherein the at least one power source is connected with the main drive of the aircraft.

4. The tail rotor system according to claim 1, wherein control and/or regulating means (5) are provided, by which the drive units (1) can be controlled and/or regulated in terms of rotational speed and/or direction of rotation.

5. The tail rotor system according to claim 4, wherein the control and/or regulating means (5) are connected with the central control and/or regulation (10) of the aircraft.

6. The tail rotor system according to claim 4, wherein the control and/or regulating means (5) are directly and/or indirectly connected with position detecting elements (8) and/or with steering means (9) of the aircraft.

7. The tail rotor system according to claim 4, wherein by the control and/or regulating means (5) in cooperation with the position detecting elements (8) and/or the steering means (9) and/or the central control and/or regulation (10) of the aircraft the tail rotor (3) can be controlled and/or regulated, preferably automatically, in terms of rotational speed and/or direction of rotaion for yaw control and/or regulation.

8. The tail rotor system according to claim 4, wherein by the control and/or regulating means (5) in cooperation with the position detecting elements (8) and/or the steering means (9) and/or the central control and/or regulation (10) of the aircraft a signal can be determined, by which it can be read off whether the tail rotor (3) must be activated for influencing the yaw control, and in dependence on this signal the tail rotor (3) can be activated and/or deactivated.

9. The tail rotor system according to claim 1, wherein the tail rotor (3) includes a shaft (4) which also is the rotor of the redundant drive units (1) or is connected with the same.

10. A method for controlling a tail rotor system for an aircraft, in particular for a helicopter, with a multi-blade tail rotor (3) with fixed blade angle of attack, wherein the tail rotor (3) is driven redundantly.

11. The method for controlling a tail rotor system according to claim 10, wherein the tail rotor (3) is activated if necessary and/or the yaw movement of the aircraft is controlled and/or regulated, preferably automatically, by the rotational speed and direction of rotation of the tail rotor (3) in dependence on the position of the aircraft and/or in dependence on the existing control commands.

12. The method for controlling a tail rotor system according to claim 10, wherein the tail rotor system includes redundant drive units (7) and that control and/or regulating means (5) are provided, by which the drive units (1) are controlled and/or regulated in terms of rotational speed and/or direction of rotation, wherein upon failure of one or more drive units (1) and/or one or more control and/or regulating means (5) the tail rotor (3) can be operated further by the remaining drive units (1).

13. The method for controlling a tail rotor system according to claim 10, wherein the tail rotor (3) is not driven in a flight-dynamically stable position of the aircraft.

14. The method for controlling a tail rotor system according to claim 10, wherein it is a tail rotor system with a multi-blade tail rotor (3) with a fixed blade angle of attack, and includes redundant drive units (1), which combine both yaw thrust generation and yaw thrust control in one unit.

15. The tail rotor system according to claim 2, wherein control and/or regulating means (5) are provided, by which the drive units (1) can be controlled and/or regulated in terms of rotational speed and/or direction of rotation.

16. The tail rotor system according to claim 3, wherein control and/or regulating means (5) are provided, by which the drive units (1) can be controlled and/or regulated in terms of rotational speed and/or direction of rotation.

17. The tail rotor system according to claim 16, wherein the control and/or regulating means (5) are connected with the central control and/or regulation (10) of the aircraft.

18. The tail rotor system according to claim 15, wherein the control and/or regulating means (5) are connected with the central control and/or regulation (10) of the aircraft.

19. The tail rotor system according to claim 18, wherein the control and/or regulating means (5) are directly and/or indirectly connected with position detecting elements (8) and/or with steering means (9) of the aircraft.

20. The tail rotor system according to claim 17, wherein the control and/or regulating means (5) are directly and/or indirectly connected with position detecting elements (8) and/or with steering means (9) of the aircraft.
